(19) United States
(12) Patent Application Publication
(10) Pub. No.: US 2026/0187082 A1
(43) Pub. Date: Jul. 2, 2026

(54) SYSTEMS AND METHODS FOR QUERYING DATABASES USING NATURAL LANGUAGE PROCESSING

(71) Applicant: Ever Careers Incorporated, Menlo Park, CA (US)

(72) Inventors: Congwen XU, Menlo Park, CA (US); Ethan KIM, Menlo Park, CA (US); Yada PRUKSACHATKUN, Menlo Park, CA (US)

(21) Appl. No.: 19/457,452

(22) Filed: Jan. 23, 2026

Related U.S. Application Data
(63) Continuation of application No. PCT/US2024/039554, filed on Jul. 25, 2024.
(60) Provisional application No. 63/515,635, filed on Jul. 26, 2023.

(51) Int. Cl. G06F 16/2457; G06F 16/2452

(52) U.S. Cl. CPC G06F 16/24578; G06F 16/24522

(57) ABSTRACT

In some aspects, the present disclosure provides a method of querying a database. In some embodiments, the method comprises receiving a natural language (NL) query from a user. In some embodiments, the method comprises translating the NL query into a domain-specific language (DSL) query comprising instructions for selecting and returning a ranked result from the database to the user. In some embodiments, the translating is based on a joint embedding space of NL queries and DSL queries. In some embodiments, the method comprises selecting the ranked result from the database using the DSL query. In some embodiments, the method comprises returning the ranked result to the user.

### CROSS-REFERENCE

This application is a continuation of International Application No. PCT/US2024/039554, filed Jul. 25, 2024, which claims the benefit of U.S. Provisional Application No. 63/515,635, filed Jul. 26, 2023, the contents of which are incorporated by reference in their entirety.

### BACKGROUND

Databases are ubiquitous in the information age. They can be used in science, art, and business to organize, store, and retrieve information.

### SUMMARY

In some aspects, the present disclosure provides a method of querying a database, comprising: receiving a natural language (NL) query from a user; translating the NL query into a domain-specific language (DSL) query comprising instructions for selecting and returning a ranked result from the database to the user, wherein the translating is based on a joint embedding space of NL queries and DSL queries; selecting the ranked result from the database using the DSL query; and returning the ranked result to the user.

In some embodiments, a first pair of NL queries is similar in the joint embedding space and a second pair of NL queries is dissimilar in the joint embedding space, wherein the first pair of NL queries comprises lower sequence similarity than the second pair of NL queries, and wherein the first pair of NL queries comprises higher semantic similarity than the second pair of NL queries.

In some embodiments, the database comprises a heterogeneous data source.

In some embodiments, the heterogeneous data source comprises numerical values, categorical values, and natural language.

In some embodiments, the translating is performed using a machine learning algorithm trained using a natural language dataset.

In some embodiments, the machine learning algorithm comprises an autoregressive algorithm.

In some embodiments, the machine learning algorithm comprises a transformer.

In some embodiments, the DSL query comprises a name field, an operator field, and a value field.

In some embodiments, the DSL query comprises context-free grammar.

In some embodiments, the translating is performed using few shot prompting.

In some embodiments, the translating comprises applying a grammar mask to the DSL query.

In some embodiments, the translating comprises performing error correction on the DSL query based on grammar correction.

In some embodiments, the grammar correction comprises cascading LLM fallbacks, an explicit correction model, or both.

In some aspects, the present disclosure provides a method of training a neural network for querying a database, comprising: providing a dataset comprising NL queries and DSL queries; and training the neural network to learn a joint embedding space using the dataset, wherein a first pair of NL queries is similar in the joint embedding space and a second pair of NL queries is dissimilar in the joint embedding space, wherein the first pair of NL queries comprises lower sequence similarity than the second pair of NL queries, and wherein the first pair of NL queries comprises higher semantic similarity than the second pair of NL queries.

In some embodiments, the training comprises contrastive learning for learning the joint embedding space.

In some embodiments, the training comprises non-contrastive learning for learning the joint embedding space.

In some embodiments, the dataset comprises synthetic NL queries, synthetic DSL queries, or both.

In some embodiments, the synthetic NL queries, synthetic DSL queries, or both are generated to approximate or match user distribution of queries.

In some embodiments, the dataset comprises positive pairs and negative pairs of NL queries and DSL queries.

In some embodiments, the negative pairs comprise hard negatives sampled from user data.

In some embodiments, the negative pairs comprise negatives sampled based on a similarity measure.

In some embodiments, the similarity measure comprises cosine similarity, maximal marginal relevance, or both.

In some aspects, the present disclosure provides a graphical user interface (GUI) for querying a database, comprising: a first graphical element for receiving a NL query from a user and translating the NL query into a DSL query, wherein the translating is based on a joint embedding space of NL queries and DSL queries; a second graphical element for receiving the DSL query from the user; and a third graphical element for returning a ranked result from the database to the user, wherein the ranked result is selected from the database using the DSL query.

In some aspects, the present disclosure provides a method of querying a database, comprising: receiving a natural language (NL) query from a user; translating the NL query into a domain-specific language (DSL) query comprising instructions for selecting and returning a ranked result from the database to the user, wherein the translating is based on an autoregressive model; selecting the ranked result from the database using the DSL query; and returning the ranked result to the user.

In some aspects, the present disclosure provides a method of querying a job database, comprising: receiving a natural language (NL) query from a user; translating the NL query into a domain-specific language (DSL) query comprising instructions for selecting and returning a ranked result from the job database to the user; selecting the ranked result from the job database using the DSL query; and returning the ranked result to the user.

In some embodiments, the ranked result comprises a list of jobs.

In some embodiments, the ranked result comprises a list of job candidates.

In some aspects, the present disclosure provides a method of querying a database, comprising: receiving a NL query from a user; translating the NL query into a DSL query comprising instructions for selecting and returning a ranked result from the database to the user, wherein the translating is based on a joint embedding space of NL queries and DSL queries, and

wherein a syntax of the DSL does not comprise an unambiguity, and wherein the joint embedding space is generated by training a machine learning model using a synthesized training data that substantially matches a distribution of user queries; selecting the ranked result from the database using the DSL query; and returning the ranked result to the user.

In some aspects, the present disclosure provides a method of querying a plurality of databases, comprising: receiving a natural language (NL) query from a user; translating the NL query into a domain-specific language (DSL) query comprising instructions for selecting and returning a ranked result from the plurality of databases to the user; selecting the ranked result from the plurality of databases using the DSL query, wherein the plurality of databases comprises different input syntax or different data structures; and returning the ranked result to the user.

In some aspects, the present disclosure provides a computer program product comprising a computer-readable medium having computer-executable code encoded therein, the computer-executable code adapted to be executed to implement any one of the methods disclosed herein.

In some aspects, the present disclosure provides a non-transitory computer-readable storage media encoded with a computer program including instructions executable by one or more processors to implement any one of the methods disclosed herein.

In some aspects, the present disclosure provides a computer-implemented system comprising: a digital processing device comprising: at least one processor, an operating system configured to perform executable instructions, a memory, and a computer program including instructions executable by the digital processing device to perform any one of the methods disclosed herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a schematic of a process for searching a database.

FIG. 2A shows a schematic of a process for building a query for a database.

FIG. 2B shows a schematic of a process for fine-tuning a large language model.

FIG. 2C shows a schematic of a retrieval system.

FIG. 3 shows a computer system.

### DETAILED DESCRIPTION

Databases are ubiquitous in the information age. They can be used in science, art, and business to organize, store, and retrieve information. The organizational structure, i.e., the schema, of databases can dictate their utility to users, accessibility to users, and data security. Naturally, the schema of databases vary widely as they are designed to fit practical necessities for particular applications. Thus, users of databases often study the scheme of a database before taking full advantage of the navigational utility and security that a database scheme provides.

In some aspects, the present application provides systems and methods for interacting with one or more databases using natural language (NL). For example, a user can enter a search query in NL and receive search results retrieved from various data sources. The various data sources can each comprise one or more databases. Each of the one or more databases can have both similarities and differences in schema with one another. By using NL, a user can retrieve information from various databases using natural expressions. One NL query can be used to interact with a number of databases that have different schema and interfaces.

However, performing NL search over datasets that have multiple fields or a particular underlying structure (such as numerical fields or categorical values) can lead to poor performance when NL is used merely with a keyword or vector search. For example, for a query such as “show me all tables less than 7 feet long and less than 500,” using solely keyword filters or vector searches may not extract that the query calls for a range of values. Furthermore, relying solely on keyword or vector searches may lead to low precision or low recall, and may miss the intent of the NL query given by the user.

Thus, in some aspects, the present application provides systems and methods for generating domain-specific language for databases based on NL. A NL search can be performed by generating an intermediate domain specific language (DSL) query which can help interpret the intent of a NL query. The DSL query can coordinate with various databases, models, and search indices to produce a ranked list of high precision, high recall matches.

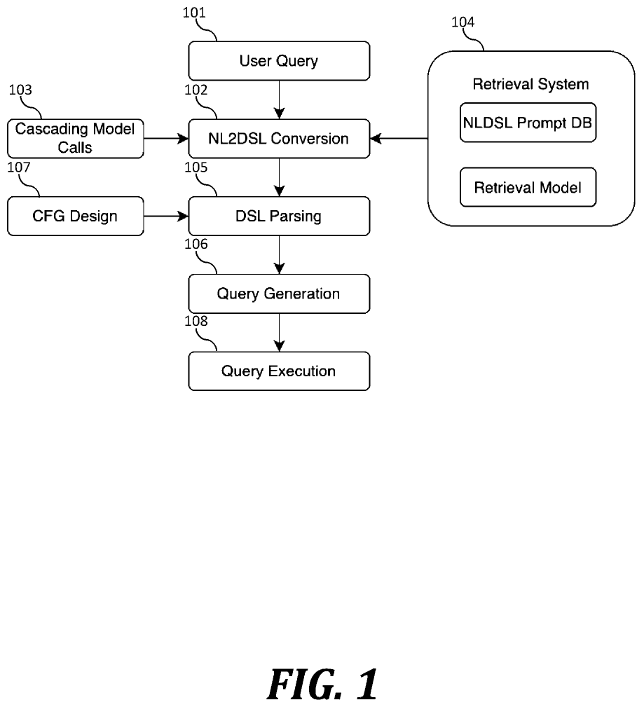

For example, a user can express a query for a set of data sources in NL. FIG. 1 shows a schematic of a process for searching a database. The NL query 101 can be converted 102 into a DSL query. The conversion can be performed using a machine learning algorithm, e.g., a large language model (LLM). The conversion can be performed using cascading model calls 103, prompt retrieval 104, or both. DSL query can comprise instructions for selecting and returning a ranked result from one or more data sources to the user. The DSL query can comprise instructions on how the query should be executed to return ranked results to the user. The DSL query can be parsed 105 to generate 106 an executable query to be used with the data sources. The parsing can be based on a context-free grammar (CFG) 107. The DSL query can be used to filter structured data. The DSL query can be used to perform a semantic search on unstructured data. The DSL query can be executed 108 on a data source. The data sources can return results, according to the natural language query, back to the user.

Accordingly, in some aspects, the present disclosure provides systems and methods that permit a natural language request to be converted into an intermediate domain-specific language that can be easily parsed and/or processed to provide directions on how to access or interact with one or more databases or active programming interfaces (APIs) to perform the natural language request.

### Domain Specific Language (DSL)

Some embodiments of DSL are designed to be able to express the full range of user queries; and/or to be simple and unambiguous in order to be easier for a machine learning algorithm to generate.

In some embodiments, a DSL can be used to query structured data sources, unstructured data sources, or both. In some embodiments, a data source can comprise one or more fields which can comprise numerical values, categorical values, unstructured data, or any combination thereof. An unstructured data, for example, can comprise natural language (e.g., a job description, or a description of a job experience).

A DSL query over a field can comprise a field name, an operator, and a value.

### NameOperatorValue

In some embodiments, a field can comprise nested properties. In some embodiments, a DSL query can reference multiple fields, contain multiple clauses, which can be joined by Boolean operators.

Some embodiments of DSL was designed to comprise a small subset of keywords and operators possible. Some embodiments of DSL comprise smaller subset of keywords and operators, compared to standards like SQL and EQL (Elasticsearch Query Language), by removing or not utilizing certain reserved keywords and functions that can be found in SQL or EQL. Some embodiments of DSL describe how the query should be executed to return ranked results to the user by accessing 1 or more search indices, databases, and/or APIs (e.g., elastic search, vector search DB, API etc). In some embodiments, the DSL can call multiple external sources sequentially or non-simultaneously or in parallel. A DSL can access and/or combine features from various types of traditional search indices, such as, keyword based search systems and vector search systems. In some embodiments, semantic parsing applied to elastic search style queries can provide more support for keyword queries, fuzzy matching and result ranking. In one example, the minimal DSL can comprise a subset of possible finite strings:
let [symbol] be a vocabulary of possible tokens
let Σ* be a set of all finite strings using [symbol]
D⊂Σ* is the DSL

In certain domains or in certain data sources, field names can have ambiguous semantics when expressed in natural language and passed to a language model. For example, given a database may comprise columns named: “car.make” and “car.model”. Therefore, some embodiments of a DSL comprises alias field names. For example, ambiguous field names can be mapped to related counterparts that can easily be disambiguated by a model—“car.make” can be mapped to “car.manufacturer” which can be easier to distinguish. A post-processing step for a DSL can ensure that the correct field name in the database is queried.

A DSL query can comprise one or more fields. For example, a field can be informative for a job searcher or a recruiter. A field can comprise a name field, an operator field, a value field, a state field. For example, in a job search database, a name field can comprise a job candidate's name, a company name, a job title, a location, a date, an educational institute name, an educational degree, or a skill. A location can be a country, a state, or a city. A date can be a year, a month, or a specific day of a year. A skill can be any skill relevant for a certain job, such as, an engineering skill, an artistic skill, a social skill, or a management skill. A value field and an operator field can be used to filter or rank results. For example, jobs “greater than” “30 miles” of a location can be filtered or ranked. In another example, job candidates with “less than” “five years” of experience can be filtered or ranked. A state field can be used to distinguish various states, e.g., “open to work” vs. “not looking for work”, “looking to hire” vs. “not looking to hire”, “High School Education” vs. “College Education” vs. “Graduate Education”.

A DSL can comprise regular grammar, context-free grammar, context-sensitive grammar, or recursively enumerable grammar. In some embodiments, a DSL query can comprise context-free grammar. Context-free grammar can be easier to process than regular grammar, e.g., in lexical analysis (lexing) and parsing, compared to a context sensitive grammar. Context-free grammar can permit larger variety of expressions than regular grammar.

### Conversion

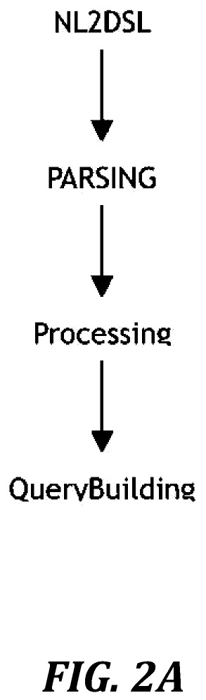

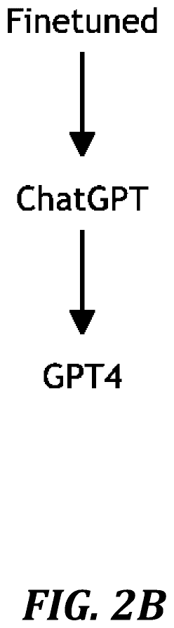

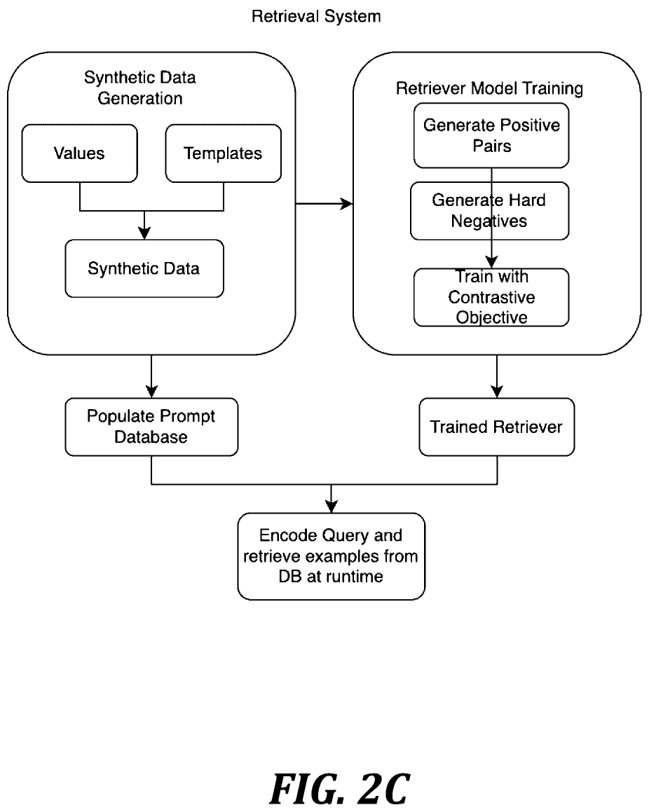

A conversion can be performed using a machine learning algorithm. FIG. 2A shows a schematic of a process for building a query for a database. A machine learning algorithm can comprise a neural network. The neural network can be trained using natural language. E.g., a neural network can be an algorithm classified as a Large Language Model (LLM). A large language model may comprise at least 1 billion parameters. In some embodiments, a neural network can comprise a distilled or pruned form of a large language model. A neural network can comprise a transformer, or a transformer-like mechanism (e.g., Receptance Weighted Key Value; RWKV). A neural network can comprise an autoregressive neural network, a recurrent neural network, or any other neural network mechanism configured to process sequence information by relating elements in a sequence. A machine learning algorithm can be, e.g., pre-trained model. A pre-trained model can be accessed via a provider API. A machine learning algorithm can be trained de novo, or be fine-tuned for a task. FIG. 2B shows a schematic of a process for fine-tuning a large language model. LLMs such as ChatGPT™, ChatGPT™-like models, and GPT-4™, can be fine-tuned with an application-specific dataset.

A conversion can be performed using zero-shot, one-shot, or few-shot prompting. For example, NL query to DSL query conversion can use few-shot prompting by providing two or more examples of correct conversion tasks. A conversion task may provide to a machine learning algorithm: a NL query and a corresponding DSL query, and optionally, a description of a conversion task, a step-by-step explanation of the conversion task, a negative example of a conversion task, a prompt generation task, a chain-of-thought task, or any combination thereof. A chain-of-thought task, for example, can be to perform step by step reasoning when performing the conversion task. A machine learning algorithm can be tasked with generating reasoning traces for synthetic examples using weak supervision. A machine learning algorithm can be tasked with combining chain-of-thought prompting with prompt retrieval.

A model (e.g., a large scale transformer with autoregressive decoding capabilities) can be prompted with several pairs of known correct input and output pairs (NL and DSL queries). A natural language to DSL pair can be defined as (n, d). Several of these pairs can be included within a context window of the language model. The model can be prompted with the user query nᵤ while asking the model to generate the DSL output dᵤ∈D.

In some embodiments, an example of a conversion task can be dynamically included in prompt. The example can be selected based on a similarity to the user input, which can better guide the machine learning algorithm to generate the correct DSL. FIG. 2C shows a schematic of a retrieval system. A large pool of NL-DSL pairs can be generated and stored, which can be used to dynamically retrieve similar examples to a user query at runtime.

In some embodiments, an example can be selected. In some embodiments, given a user NL query, a set of top k examples can be retrieved by cosine similarity and included in the prompt. In some embodiments, given a user NL query, a set of top k examples can be retrieved by maximal marginal relevance. Maximal marginal relevance can emphasize the diversity of the included examples, expressed as:

$$examples = arg {max}_{{n}_{i} ∈ N} sim ( {n}_{i} , {n}_{u} )$$

wherein nᵢ and nᵤ refers to a query in a pool and a user query, respectively. The similarity function, sim, can be one of various measures of similarity, e.g., distance or cosine similarity based on sequence or embedding space representation. Examples can be retrieved based on the similarity to the user's natural language query. Then, the retrieved (n, d) NL-DSL query pairs can be included in a prompt. In some embodiments, prompt retrieval scales up the expressivity of the conversion task for a machine learning algorithm. Including examples can help the machine learning algorithm generate larger or nuanced DSLs. Training the retrieval model can improve performance, especially on rare or ambiguous queries.

In some embodiments, the pool can be updated. The pool can be updated by, for example, adding or removing examples. An example can be deleted if the example is an incorrectly labeled positive pair of NL and DSL queries. An example can be deleted if the example is determined to be outside of the user distribution of queries. An example can be added if a user's NL query produces an accurate DSL. Updating the pool can update the behavior of a machine learning algorithm, without requiring the retraining or tuning the machine learning algorithm's parameters. Retraining or tuning may not be required to improve the machine learning algorithm's outputs, since improved information regarding accurate NL and DSL pairs can be aggregated into an independent database (e.g., the pool) that is used to prompt the machine learning algorithm. Thus, accurate outputs of the machine learning model can be reinforced by adding successful examples, and inaccurate outputs of the machine learning can be reduced by removing unsuccessful examples. Consider an incorrect example (n, di) for which a corrected DSL is identified. The example pool can be updated with the corrected example (n, d_{c}). Correcting behavior for a single example can correct behavior for that example as well as a class of examples having semantic or sequence similarities.

After updating the pool with the corrected example, the similarity search for NL, n, can include (n, d_{c}) as the top result. In addition, any queries that are semantically close enough to n can also retrieve (n, d_{c}) as an example in the top k results and display the correct generation. Thus retrieval can scale error correction for a wider range of natural language queries.

A machine learning algorithm can be trained to map similar NL queries and/or DSL queries close together in the input space. Similar NL queries can be queries with different sequences but equivalent semantics. For example, “I want a red car” and “The car's color should be red” comprises equivalent semantic information for the purpose of searching a car that is red (e.g., a corresponding DSL query may be “car.color=red”). However, a linear tokenization of the two NL queries may be drastically different. In other words, a vector representing the sequence {“I”, “want”, “a”, “red”, “car”} versus a vector which represents {“The”, “car's”, “color”, “should”, “be”, “red”} may have very little resemblance with one another. In contrast, a vector representing the sequence {“I”, “want”, “a”, “red”, “car”} versus a vector which represents {“I”, “want”, “a”, “blue”, “car”} may have relatively high sequence resemblance with one another, compared to the previous example given, even though the semantic information is at odds with one another. Pairs which have high sequence similarity but different semantic meanings can be used as “hard negatives” during training. During training, NL queries that comprise different sequences but have the same corresponding DSL can be used as positive pairs, so that semantically equivalent or similar NL queries can be trained to be embedded proximal to one another in the embedding space. During training, NL queries that comprise similar sequences but have different corresponding DSLs can be used as negative pairs, so that semantically non-equivalent or dissimilar NL queries can be trained to be embedded distant from one another in the embedding space.

The converting from the NL query to the DSL query can be based on a joint embedding space of NL queries and DSL queries. Semantically equivalent or similar NL and DSL pairs can jointly be embedded into the latent space. Thus, a machine learning algorithm can be configured to determine one or more coordinates in the joint embedding space from a given query (either NL or DSL). A machine learning algorithm can be configured to determine a query (either NL or DSL) from one or more coordinates in the joint embedding space. The joint embedding space can be generated using contrastive learning, although, non-contrastive learning approaches can also be used.

The properties of the joint embedding space can comprise any one of the following. In some embodiments, semantically equivalent pairs of NL queries can comprise the same coordinates in the embedding space. In some embodiments, semantically equivalent pairs of NL queries can comprise a more proximal coordinates or a more similar vector in the embedding space, compared to semantically nonequivalent pairs of NL queries. In some embodiments, semantically equivalent pairs of a NL query and a DSL query can comprise the same coordinates in the embedding space. In some embodiments, semantically equivalent pairs of a NL query and a DSL query can comprise a more proximal coordinates or a more similar vector in the embedding space, compared to semantically nonequivalent pairs of NL queries. In some embodiments, semantically similar pairs of NL queries can comprise a more proximal coordinates or a more similar vector in the embedding space, compared to semantically dissimilar pairs of NL queries. In some embodiments, semantically similar pairs of a NL query and a DSL query can comprise the same coordinates in the embedding space. In some embodiments, semantically similar pairs of a NL query and a DSL query can comprise a more proximal coordinates or a more similar vector in the embedding space, compared to semantically dissimilar pairs of NL queries. Semantically equivalent pairs of NL or DSL queries can comprise the same or similar coordinates or vectors while elements of the pairs comprise dissimilar sequences. Semantically nonequivalent pairs of NL or DSL queries can comprise different or dissimilar coordinates or vectors while elements of the pairs comprise similar sequences. In some embodiments, a first pair of NL queries is similar in the joint embedding space and a second pair of NL queries is dissimilar in the joint embedding space, wherein the first pair of NL queries comprises lower sequence similarity than the second pair of NL queries, and wherein the first pair of NL queries comprises higher semantic similarity than the second pair of NL queries.

In some embodiments, error correction can be performed on a DSL query. The DSL string generated by a machine learning algorithm can be parsed to a structured representation following a grammar rule. The grammar rule can comprise, e.g., a context-free grammar rule. A grammar rule can be based on or derived from ANother Tool for Language Recognition (ANTLR). A grammar rule or a grammar ruleset can define a DSL as a subset of possible strings. L(G) can be defined as a set of possible strings accessible via the production rules of a grammar G:

$$D ⊂ L ( G ) ⊂ {\sum }^{*} .$$

A grammar rule can define allowed fields, operators and values. A grammar rule can support parsing of complex combinations of fields. In some embodiments, arbitrary parsing of nested Boolean expressions can be supported. A grammar rule can be a structured object representing the query. A grammar rule can be used to enforce grammatically-correct DSL outputs to produce grammatically correct outputs (e.g., balancing parentheses).

A defined grammar rule or ruleset of a DSL can permit error handling. Any grammatically invalid generated DSL queries can be routed for error correction. Invalid DSL queries can be corrected for issues such as invalid operators, mis-spelled column names, wrongly formatted values, and etc.

In some embodiments, error correction can comprise cascading LLM fallbacks. Cascading fallbacks can call models with increasing capability in order to resolve errors. For example, a machine learning algorithm with increasing large context windows may be called until a valid string is generated. Recognizing that certain machine learning algorithms, such as, LLMs may have tradeoffs in terms of performance, latency and cost, the cascading fallbacks can start with the cheapest and/or lowest capacity model in a selection of different models. If model generates a grammatically incorrect output, a higher level capability model can be called in order to generate a correct output.

In some embodiments, a machine learning algorithm can be used to correct a grammatically invalid DSL query. For example, a machine learning algorithm can be used to take a grammatically incorrect DSL query along with the user NL as input, and generate a corrected DSL query as output. Using the grammar rule or ruleset as a source of supervision, DSL query can be iteratively refined until a grammatically correct output is generated.

In some embodiments, error correction can comprise an explicit correction model. When generating from a machine learning algorithm, a grammar rule or ruleset can be used for constrained decoding. Constrained decoding may comprise, e.g., during an autoregressive sampling stage, enforcing a grammar rule or a grammar ruleset. For example, during a DSL generation, the output of a machine learning model can be parsed incrementally (e.g., by token by token) and it can be ensured that each generated token follows the grammar specification. Some autoregressive language models can generate tokens sequentially, one token at a time. Some autoregressive language models can comprise a set of tokens defining a vocabulary V. The model can predict a probability distribution over V. In order to performed constrained decoding, a mask can be applied to the vocabulary:

$$m ∈ {\{ 0 , 1 \}}^{\vert V \vert}$$

In some embodiments, the outputs (e.g., which can be a vector representing the probabilities of the next token) of a machine learning algorithm can be multiplied by the mask:

$$m ⊙ softmax ( z )$$

An incremental parsing function can be defined, ƒ, which given a partially constructed sequence and a grammar G, can return the decoding mask for the next token:

$$m = f ( s , G )$$

Therefore, a mask can constrain the set of possible next tokens to those that are grammatically correct. When using constrained decoding, the machine learning algorithm can be forced to generate grammatically valid DSL statements.

In some embodiments, a DSL query can be converted into an executable DSL query. In some embodiments, a parsed DSL object is an abstract representation of the user query which is to be converted into a concrete executable. The conversion can be based on a mapping system between the DSL query and a specific query language. For example, a DSL query can comprise the semantic meaning of a user's query as a string. To execute on the DSL on a database of interest, the string may be converted into a form that the database is receptive to.

A DSL query can be recursively parsed into a query. A mapping can comprising mapping DSL aliased field names to field names of a search index of a database. A mapping can comprise mapping Boolean operators for joining separate clauses in a DSL query to the appropriate operators for a database. A mapping can comprise mapping query operators within DSL clauses into equivalent operators for a database. A mapping can comprise processing each clause in a DSL query by applying appropriate formatting to a field name, an operator, a value, or any combination thereof.

The converting from the NL query to the DSL query can comprise term expansion. A user can enter a NL query using one term, and the conversion can expand the term to include synonymous or similar terms in the DSL. For example, “software engineer” can be expanded to include “computer scientist” and “computer programmer”. Another example is expanding “AI startups” into a list of known AI startups.

### Architecture

In some embodiments, systems and methods of the present disclosure may comprise a neural network or comprise using a neural network. The neural network may comprise various architectures, loss functions, optimization algorithms, assumptions, and various other neural network design choices. In some embodiments, the neural network comprises an encoder. In some embodiments, the neural network comprises a decoder. In some embodiments, the neural network comprises a bottleneck architecture comprising the encoder and the decoder. In some embodiments, the bottleneck architecture comprises an autoencoder.

In some embodiments, the neural network comprises a language model. In some embodiments, the language model is a long-short-term-memory model (LSTM). In some embodiments, the language model is a convolutional neural network. In some embodiments, the language model is an autoregressive model. As used herein, a language model may refer to any neural network or algorithm configured to process semantically correct and interpretable representation of natural language, queries, etc.

In some embodiments, the neural network comprises a convolutional layer. In some embodiments, the neural network comprises a densely-connected layer. In some embodiments, the neural network comprises a skip connection. In some embodiments, the neural network may comprise graph convolutional layers. In some embodiments, the neural network may comprise message passing layers. In some embodiments, the neural network may comprise attention layers. In some embodiments, the neural network may comprise recurrent layers. In some embodiments, the neural network may comprise a gated recurrent unit. In some embodiments, the neural network may comprise reversible layers. In some embodiments, the neural network may comprise a neural network with a bottleneck layer. In some embodiments, the neural network may comprise residual blocks. In some embodiments, the neural network may comprise one or more dropout layers. In some embodiments, the neural network may comprise one or more batch normalization layers. In some embodiments, the neural network may comprise one or more pooling layers. In some embodiments, the neural network may comprise one or more upsampling layers. In some embodiments, the neural network may comprise one or more max-pooling layers. Various types of layers may be used.

In some embodiments, the neural network comprises a graph model. In some embodiments, a graph, graph model, and graphical model can refer to a method that models data in a graphical representation comprising nodes and edges. In some embodiments, the data may be stored in a various and alternative forms such as linked lists, dictionaries, spreadsheets, arrays, in permanent storage, in transient storage, and so on, and is not limited to specific embodiments disclosed herein.

In some embodiments, the neural network may comprise an autoencoder. In some embodiments, the neural network may comprise a variational autoencoder. In some embodiments, the neural network may comprise a generative adversarial network. In some embodiments, the neural network may comprise a flow model. In some embodiments, the neural network may comprise an autoregressive model.

The neural network may comprise various activation functions. In some embodiments, an activation function may be a non-linearity. In some embodiments, the neural network may comprise one or more activation functions. In some embodiments, the neural network may comprise a ReLU, softmax, tanh, sigmoid, softplus, softsign, selu, elu, exponential, LeakyReLU, or any combination thereof. Various activation functions may be used with a neural network, without departing from the inventive concepts disclosed herein.

In some embodiments, the neural network may comprise a regression loss function. In some embodiments, the neural network may comprise a logistic loss function. In some embodiments, the neural network may comprise a variational loss. In some embodiments, the neural network may comprise a prior. In some embodiments, the neural network may comprise a Gaussian prior. In some embodiments, the neural network may comprise a non-Gaussian prior. In some embodiments, the neural network may comprise an adversarial loss. In some embodiments, the neural network may comprise a reconstruction loss. In some embodiments, the neural network may be trained with the Adam optimizer. In some embodiments, the neural network may be trained with the stochastic gradient descent optimizer. In some embodiments, the neural network hyperparameters are optimized with Gaussian Processes. In some embodiments, the neural network may be trained with train/validation/test data splits. In some embodiments, the neural network may be trained with k-fold data splits, with any positive integer for k. A neural network may be trained with various loss functions whose derivatives may be computed to update one or more parameters of the neural network. A neural network may be trained with hyperparameter searching algorithms.

### End-to-End System

In some embodiments, a method of the present disclosure can be implemented on an end-to-end system. An end-to-end system can comprise a graphical user interface (GUI) or a terminal. An end-to-end system can comprise an element for receiving a NL query from a user and translating the NL query into a DSL query. The translating can be based on a joint embedding space of NL queries and DSL queries. An end-to-end system can comprise an element for receiving the DSL query from the user. An end-to-end system can comprise an element returning a ranked result from the database to the user. The ranked result can be selected from the database using the DSL query.

In some aspects, the present disclosure provides, a graphical user interface (GUI) for querying a database. In some embodiments, a GUI comprises a first graphical element for receiving a NL query from a user and translating the NL query into a DSL query. In some embodiments, a GUI comprises a second graphical element for receiving the DSL query from the user. In some embodiments, a GUI comprises a third graphical element for returning a ranked result from the database to the user.

In some embodiments, an end-to-end system can incorporate positive feedback, negative feedback, or both, from one or more users to improve the system. The end-to-end system can leverage a carefully designed DSL and grammar, synthetic data generation, a retrieval system and guided LLM decoding. The components in the pipeline described above enabled various functionalities in an end to end search system. In some embodiments, users can directly express their queries in the DSL rather than in natural language. In some embodiments, a DSL query can be expanded to searches with synonymous terms. In some embodiments, a DSL query can be relaxed on some Boolean constraints within the query. In some embodiments, a route to vector or keyword search can be performed using a DSL query. In some embodiments, routing can refer to the ability of a DSL to define terms of a search query that enter on keyword search, e.g., exact term matching, or a vector search. A vector search can comprise searching a latent vector (which can be an encoding of semantic information) of a DSL query.

### Databases

In some embodiments, the platforms, systems, media, and methods disclosed herein include one or more databases, or use of the same. In some embodiments, a database can comprise structured data. In some embodiments, a database can comprise unstructured data. In some embodiments, a database can comprise semi-structured data. In some embodiments, a database can comprise heterogeneous data. In some embodiments, a database comprises tabular data, relational data, unstructured data, or any combination thereof. In some embodiments, a database does not comprises tabular data, relational data, unstructured data, or any combination thereof.

A database can be interrogated with DSL queries. Structured data of a database can be interrogated with structured DSL queries, e.g., comprising a field, an operator, and a value. Unstructured data of a database can be interrogated with semantic search over vector indices, in contrast to searching over structured numerical or categorical fields. In some embodiments, semantic search can be performed over text fields, e.g., over embeddings of sentences, paragraphs, and portions of or the entireties of documents. In some embodiments, semantic search can be performed as a multimodal search over various types of data (e.g., specially trained embeddings, images, audio, or video).

In view of the disclosure provided herein, various databases are suitable for storage and retrieval of information about NL queries, DSL queries, parameters of machine learning algorithm weights, or any combination thereof. In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

In some embodiments, a database can comprise subject profiles. The subject can be, e.g., an employee, an employer, or a job candidate. The database can be specific to an industry. For example, the database can comprise subject profiles for job candidates in sales domains. In some embodiments, a database can comprise public data, e.g., those aggregated through data sources such as LinkedIn, GitHub, Google, etc. The database can be built separate from the data sources, or can be accessed via active programming interfaces (APIs). In some embodiments, a database can comprise private database. For example, a private database can comprise an enterprise data system, applicant tracking system (ATS), customer relationship management system (CRMs), etc.

A database can comprise data on people, products, markets, companies, jobs, the economy, user engagement, demand and supply, relationship, etc. Database of products can comprise listing of products such as those on online shopping websites, like Amazon and Ebay. A database of user engagement can comprise information on measures of engagement with content, e.g., the number of views or likes on social media content. A database of demand and supply can comprise information on the number of viewers on a product and the number of units of the product available. In some embodiments, a database can be an internal database for a company or a collection of affiliated companies. In some embodiments, a database can comprise an e-commerce database, an enterprise SaaS database, a human resources database, sales database, marketing database, or any combination thereof.

### Generative Language Model Augmentation

In some embodiments, systems and methods of the present disclosure can be used to augment a generative language model. A generative language model can refer to a model that can generate spoken or written language. A generative language model can generate, for example, words, phrases, sentences, paragraphs, essays, books, or any combination thereof, i.e., compositions at various levels of complexities. A LLM is an example of a generative language model.

In some embodiments, the systems and methods of the present disclosure can be used by a generative language model to search a database. For example, a LLM may be prompted with a NL query which, on its face, may not appear to require searching a database. An example of such a query can be: “Can you tell me what kind of skills I should look for in a senior-level programmer that will lead a project for developing medical software?” Based on this query, a LLM can generate a different NL query for searching a database of job search postings, a database of professional social media profiles of senior-level programmers (e.g., on LinkedIn), or both to obtain information on relevant skills for the senior-level programmer. The LLM can also provide a NL query for searching an encyclopedic database to determine what programming languages, software knowledge, regulatory knowledge, etc. would be useful for the senior-level programmer. These newly generated NL queries can be provided to a system for querying a database. The system can generate DSL queries based on the new queries, search the databases, and return retrieved information to the LLM.

Accordingly, in some embodiments, a DSL query can be generated based on NL queries generated by a generative language model. The generative language model can generate the NL queries based on a request from a human user. The request from a human user may comprise semantically different meaning from the generated NL queries. The request from a human user may be generic. The generated NL queries may request specific information from a database for satisfying the human user's request. The request from a human user may be very specific. The generated NL queries may request specific information from a database to offer a better alternative to the human user's request. The generated NL queries may be used to retrieve useful information via DSL queries, wherein the useful information can be evaluated by the generative language model when returning an answer to the human user.

### Computing System

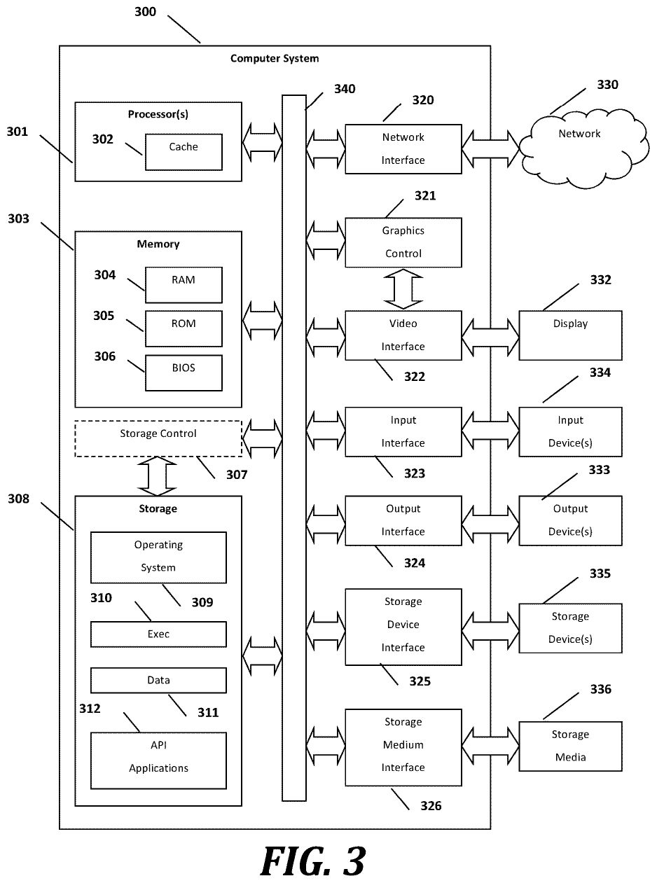

In some aspects, the present disclosure describes a computer-implemented system comprising: a digital processing device comprising: at least one processor, an operating system configured to perform executable instructions, a memory, and a computer program including instructions executable by the digital processing device to receive or generate a NL query, a DSL query, an executable query, a ranked result, or any combination thereof. In some aspects, the present disclosure describes a computer-implemented method, implementing any one of the methods disclosed herein in a computer system. Referring to FIG. 3, a block diagram is shown depicting an exemplary machine that includes a computer system 300 (e.g., a processing or computing system) within which a set of instructions can execute for causing a device to perform or execute any one or more of the aspects and/or methodologies for receiving or generating a NL query, a DSL query, an executable query, a ranked result, or any combination thereof. The components in FIG. 3 are examples only and do not limit the scope of use or functionality of any hardware, software, embedded logic component, or a combination of two or more such components implementing particular embodiments.

Computer system 300 may include one or more processors 301, a memory 303, and a storage 308 that communicate with each other, and with other components, via a bus 340. The bus 340 may also link a display 332, one or more input devices 333 (which may, for example, include a keypad, a keyboard, a mouse, a stylus, etc.), one or more output devices 334, one or more storage devices 335, and various tangible storage media 336. All of these elements may interface directly or via one or more interfaces or adaptors to the bus 340. For instance, the various tangible storage media 336 can interface with the bus 340 via storage medium interface 326. Computer system 300 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 300 includes one or more processor(s) 301 (e.g., central processing units (CPUs), general purpose graphics processing units (GPGPUs), or quantum processing units (QPUs)) that carry out functions. Computer system 300 may be one of various high performance computing platforms. For instance, the one or more processor(s) 301 may form a high performance computing cluster. In some embodiments, the one or more processors 301 may form a distributed computing system connected by wired and/or wireless networks. In some embodiments, arrays of CPUs, GPUs, QPUs, or any combination thereof may be operably linked to implement any one of the methods disclosed herein. Processor(s) 301 optionally contains a cache memory unit 302 for temporary local storage of instructions, data, or computer addresses. Processor(s) 301 are configured to assist in execution of computer readable instructions. Computer system 300 may provide functionality for the components depicted in FIG. 3 as a result of the processor(s) 301 executing non-transitory, processor-executable instructions embodied in one or more tangible computer-readable storage media, such as memory 303, storage 308, storage devices 335, and/or storage medium 336. The computer-readable media may store software that implements particular embodiments, and processor(s) 301 may execute the software. Memory 303 may read the software from one or more other computer-readable media (such as mass storage device(s) 335, 336) or from one or more other sources through a suitable interface, such as network interface 320. The software may cause processor(s) 301 to carry out one or more processes or one or more steps of one or more processes described or illustrated herein. Carrying out such processes or steps may include defining data structures stored in memory 303 and modifying the data structures as directed by the software.

The memory 303 may include various components (e.g., machine readable media) including, but not limited to, a random access memory component (e.g., RAM 304) (e.g., static RAM (SRAM), dynamic RAM (DRAM), ferroelectric random access memory (FRAM), phase-change random access memory (PRAM), etc.), a read-only memory component (e.g., ROM 305), and any combinations thereof. ROM 305 may act to communicate data and instructions unidirectionally to processor(s) 301, and RAM 304 may act to communicate data and instructions bidirectionally with processor(s) 301. ROM 305 and RAM 304 may include any suitable tangible computer-readable media described below. In one example, a basic input/output system 306 (BIOS), including basic routines that help to transfer information between elements within computer system 300, such as during start-up, may be stored in the memory 303.

Fixed storage 308 is connected bidirectionally to processor(s) 301, optionally through storage control unit 307. Fixed storage 308 provides additional data storage capacity and may also include any suitable tangible computer-readable media described herein. Storage 308 may be used to store operating system 309, executable(s) 310, data 311, applications 312 (application programs), and the like. Storage 308 can also include an optical disk drive, a solid-state memory device (e.g., flash-based systems), or a combination of any of the above. Information in storage 308 may, in appropriate cases, be incorporated as virtual memory in memory 303.

In one example, storage device(s) 335 may be removably interfaced with computer system 300 (e.g., via an external port connector (not shown)) via a storage device interface 325. Particularly, storage device(s) 335 and an associated machine-readable medium may provide non-volatile and/or volatile storage of machine-readable instructions, data structures, program modules, and/or other data for the computer system 300. In one example, software may reside, completely or partially, within a machine-readable medium on storage device(s) 335. In another example, software may reside, completely or partially, within processor(s) 301.

Bus 340 connects a wide variety of subsystems. Herein, reference to a bus may encompass one or more digital signal lines serving a common function, where appropriate. Bus 340 may be any of several types of bus structures including, but not limited to, a memory bus, a memory controller, a peripheral bus, a local bus, and any combinations thereof, using any of a variety of bus architectures. As an example, and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 300 may also include an input device 333. In one example, a user of computer system 300 may enter commands and/or other information into computer system 300 via input device(s) 333. Examples of an input device(s) 333 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 333 may be interfaced to bus 340 via any of a variety of input interfaces 323 (e.g., input interface 323) including, but not limited to, serial, parallel, game port, USB, FIREWIRE, THUNDERBOLT, or any combination of the above. In some embodiments, an input device 333 may be used to receive or generate a NL query, a DSL query, an executable query, a ranked result, or any combination thereof. In some embodiments, a method comprises using human inputs through an input device 333.

In particular embodiments, when computer system 300 is connected to network 330, computer system 300 may communicate with other devices, specifically mobile devices and enterprise systems, distributed computing systems, cloud storage systems, cloud computing systems, and the like, connected to network 330. Communications to and from computer system 300 may be sent through network interface 320. For example, network interface 320 may receive incoming communications (such as requests or responses from other devices) in the form of one or more packets (such as Internet Protocol (IP) packets) from network 330, and computer system 300 may store the incoming communications in memory 303 for processing. Computer system 300 may similarly store outgoing communications (such as requests or responses to other devices) in the form of one or more packets in memory 303 and communicated to network 330 from network interface 320. Processor(s) 301 may access these communication packets stored in memory 303 for processing.

Examples of the network interface 320 include, but are not limited to, a network interface card, a modem, and any combination thereof. Examples of a network 330 or network segment 330 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 330, may employ a wired and/or a wireless mode of communication. In general, any network topology may be used.

Information and data can be displayed through a display 332. Examples of a display 332 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 332 can interface to the processor(s) 301, memory 303, and fixed storage 308, as well as other devices, such as input device(s) 333, via the bus 340. The display 332 is linked to the bus 340 via a video interface 322, and transport of data between the display 332 and the bus 340 can be controlled via the graphics control 321. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 332, computer system 300 may include one or more other peripheral output devices 334 including, but not limited to, an audio speaker, a printer, a storage device, and any combinations thereof. Such peripheral output devices may be connected to the bus 340 via an output interface 324. Examples of an output interface 324 include, but are not limited to, a serial port, a parallel connection, a USB port, a FIREWIRE port, a THUNDERBOLT port, and any combinations thereof.

In addition, or as an alternative, computer system 300 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, and tablet computers.

In some embodiments, the computing device includes an operating system configured to perform executable instructions. The operating system is, for example, software, including programs and data, which manages the device's hardware and provides services for execution of applications. Various suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Various suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Various suitable mobile smartphone operating systems include, by way of non-limiting examples, Nokia® Symbian® OS, Apple® Ios®, Research In Motion® BlackBerry OS®, Google® Android®, Microsoft® Windows Phone® OS, Microsoft® Windows Mobile® OS, Linux®, and Palm® WebOS®.

In some embodiments, a computer system 300 may be accessible through a user terminal to receive user commands. The user commands may include line commands, scripts, programs, etc., and various instructions executable by the computer system 300. A computer system 300 may receive instructions to receive or generate a NL query, a DSL query, an executable query, or any combination thereof, or schedule a computing job for the computer system 300 to carry out any instructions, e.g., train a machine learning algorithm.

### Non-Transitory Computer Readable Storage Medium

In some aspects, the present disclosure describes a non-transitory computer-readable storage media encoded with a computer program including instructions executable by one or more processors to receive or generate a NL query, a DSL query, an executable query, a ranked result, or any combination thereof using any one of the methods disclosed herein. In some embodiments, a non-transitory computer-readable storage media may comprise a database of NL queries, DSL queries, executable queries, machine learning model weights, or any combination thereof. In some embodiments, the platforms, systems, media, and methods disclosed herein include one or more non-transitory computer readable storage media encoded with a program including instructions executable by the operating system of an optionally networked computing device.

In further embodiments, a computer readable storage medium is a tangible component of a computing device. In still further embodiments, a computer readable storage medium is optionally removable from a computing device. In some embodiments, a computer readable storage medium includes, by way of non-limiting examples, flash memory devices, solid state memory, magnetic disk drives, magnetic tape drives, optical disk drives, distributed computing systems including cloud computing systems and services, and the like. In some embodiments, the program and instructions are permanently, substantially permanently, semi-permanently, or non-transitorily encoded on the media.

### Computer Program

In some aspects, the present disclosure describes a computer program product comprising a computer-readable medium having computer-executable code encoded therein, the computer-executable code adapted to be executed to implement any one of the methods disclosed herein. In some embodiments, the platforms, systems, media, and methods disclosed herein include at least one computer program, or use of the same.

A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, a computer program may be written in various versions of various languages. In some embodiments, APIs may comprise various languages, for example, languages in various releases of TensorFlow, Theano, Keras, PyTorch, or any combination thereof which may be implemented in various releases of Python, Python3, C, C#, C++, MatLab, R, Java, or any combination thereof.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more standalone applications, one or more web browser plug-ins, extensions, add-ins, or add-ons, or combinations thereof.

### Web Application

In some embodiments, a computer program includes a web application. In some embodiments, a user may enter a query through a web application. A web application can be, for example, a plug-in such as a toolbar. In some embodiments, a user may receive a ranked result through a web application. In light of the disclosure provided herein, a web application, in various embodiments, utilizes one or more software frameworks and one or more database systems. In some embodiments, a web application is created upon a software framework such as Microsoft® NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft® SQL Server, mySQL™, and Oracle®. A web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® ActionScript, JavaScript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by various techniques using hardware, languages, and development environments. Mobile applications may be written in various languages. Suitable programming languages include, by way of non-limiting examples, C, C++, C#, Objective-C, Java™, JavaScript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (Ios) SDK, Android™ SDK, BlackBerry® SDK, BREW SDK, Palm® OS SDK, Symbian SDK, webOS SDK, and Windows® Mobile SDK.

### Standalone Application

In some embodiments, a computer program includes a standalone application, which is a program that is run as an independent computer process, not an add-on to an existing process, e.g., not a plug-in. Standalone applications may be compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB.NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by various techniques using machines, software, and languages. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location. In some embodiments, software modules comprise an e-commerce software, an enterprise SaaS software, human resources software, sales software, marketing software, a search software, an enterprise data management software, a data analytics software, or any combination thereof.

### EXAMPLES

The following examples are provided to further illustrate some embodiments of the present disclosure, but are not intended to limit the scope of the disclosure; it will be understood by their exemplary nature that other procedures, methodologies, or techniques may alternatively be used.

### Example 1: Training a Machine Learning Algorithm for Retrieving Similar NL and DSL Pairs to an NL Query

Methods and systems of the present disclosure were used to train a machine learning model. The training can involve using one or more of various loss functions. In this example, a normalized temperature scaled cross entropy loss with a very large contrastive batch size was used to train a Bidirectional Encoder Representations from Transformers (BERT)-like model. In order to increase the contrastive batch size, training was performed across multiple GPUs, and negative examples were gathered on each device during training. The trained model was used to convert NL queries into a vector. In comparison, certain vanilla GPT, RNN, RWKV, or autoregressive models may generate text but not vectors.

Hard negatives were generated for training the machine learning algorithm. As discussed previously, hard negatives may have sequence similarities in NL, but may have different DSL. Hard negatives were mined using a variety of heuristics and to address specific errors in the system.

One heuristic used was to mine queries may have overlapping terms but should result in different DSL. For example, queries such as “Miles per gallon should be less than 20” and “Miles per gallon should be more than 20” were used as hard negatives. The two queries have a high n-gram overlap and can be difficult for an out of the box retriever model to disambiguate differences in the semantic meaning. Such examples were mined, and then presented as hard negatives during the retrieval model training step. NL examples were specifically mined where the expected DSL differs only with respect to the operator used. For instance:

$$car . mpg > 20$$

$$car . mpg < 20$$

These DSL statements are different so we treat the corresponding NL queries as a negative pair.

Negative examples were included as batch negatives during contrastive training. One hard negative was included per example.

The data used for training and prompting models was partially synthetically generated using a composable templating framework. FIG. 2C shows a schematic of a retrieval system. One level of synthetic data generation involved constructing a Natural Language and DSL pair based on a template for a specific field. The natural language template contained relevant field specific natural language as well as a placeholder that can be filled in with field specific values. For example, the following illustrates a natural language template for a “car color field”:
I want a car that is {color}

A list of field specific values may then be defined. For example, allowed colors of cards may be “red, green, blue etc”. To generate the NL query, the template was filled with one or more sample values, for example, choosing the value “red” for the above example generates the a NL query that states “I want a car that is red”.

The DSL template comprised the field name which can be aliased, a relevant operator and the value. To continue with the above example, a corresponding DSL query that is constructed would state:
car.color={color}

DSL templates were filled in conjunction with the NL templates in order to generate the synthetic NL-DSL pairs for the training data. Then, the machine learning algorithm was trained on the corresponding pairs, for example:
I want a car that is red→car.color=red

Multiple NL templates were defined for the same field. For example, the color field may have additional templates:
car should be {color} or car color should be {color}

By combining multiple templates and multiple values, a large data set of synthetic NL-DSL pairs were combinatorically generated.

Separate NL and DSL templates were also defined for the permitted operators for a field. For example, a numerical operator may allow the following operators. In NL, it comprised phrases such as “at least”, “greater than”, “at most”, “less than”, “greater than or equal to”, “less than equal to”, “equals”, “is”, etc., and in DL it comprised operators such as “>”, “=”, “<”. Templates for each operator was defined in order to generate valid NL-DSL pairs.

The data generation framework allowed flexibility in composing queries and templates for multiple fields, multiple different attributes of a nested field, different operators, and etc. Given the space of grammatically valid DSL generations: L(G)∈Σ*, the synthetically generated data distribution Dₛ⊂L(G) was adapted to match the expected distribution of user queries and corresponding DSL. Generated examples were constrained to the space of semantically valid NL inputs and corresponding DSL.

For example, synthetic and user distribution may be matched along one or more the following dimensions: compatible fields and values (e.g., car.make is (Honda/Toyota); expected distributions of numerical values (e.g., 20<car.mpg<50); expected combinations of queries on multiple fields (e.g., car make and model are often queries together). These combinations were extracted from actual user queries. By setting the synthetically generated DSL distribution to match the expected query DSL generation, the synthetic data was useful for guiding DSL generation from real user queries.

While preferred embodiments of the present disclosure have been shown and described herein, it will be apparent that such embodiments are provided by way of example only. Numerous variations, changes, and substitutions will now occur without departing from the disclosure. It should be understood that various alternatives to the embodiments of the present disclosure may be employed in practicing the present disclosure. It is intended that the following claims define the scope of the present disclosure and that methods and structures within the scope of these claims and their equivalents be covered thereby.

What is claimed is:

1. A method of querying a database, comprising:
a. receiving a natural language (NL) query from a user;
b. translating the NL query into a domain-specific language (DSL) query comprising instructions for selecting and returning a ranked result from the database to the user, wherein the translating is based on a joint embedding space of NL queries and DSL queries;
c. selecting the ranked result from the database using the DSL query; and
d. returning the ranked result to the user.

2. The method of claim 1, wherein a first pair of NL queries is similar in the joint embedding space and a second pair of NL queries is dissimilar in the joint embedding space, wherein the first pair of NL queries comprises lower sequence similarity than the second pair of NL queries, and wherein the first pair of NL queries comprises higher semantic similarity than the second pair of NL queries.

3. The method of claim 1, wherein the database comprises a heterogeneous data source.

4. The method of claim 3, wherein the heterogeneous data source comprises numerical values, categorical values, and natural language.

5. The method of claim 1, wherein the translating is performed using a machine learning algorithm trained using a natural language dataset.

6. The method of claim 5, wherein the machine learning algorithm comprises an autoregressive algorithm.

7. The method of claim 5, wherein the machine learning algorithm comprises a transformer.

8. The method of claim 1, wherein the DSL query comprises a name field, an operator field, and a value field.

9. The method of claim 1, wherein the DSL query comprises context-free grammar.

10. The method of claim 1, wherein the translating is performed using few shot prompting.

11. The method of claim 1, wherein the translating comprises applying a grammar mask to the DSL query.

12. The method of claim 1, wherein the translating comprises performing error correction on the DSL query based on grammar correction.

13. The method of claim 12, wherein the grammar correction comprises cascading LLM fallbacks, an explicit correction model, or both.

14. A method of training a neural network for querying a database, comprising:
a. providing a dataset comprising NL queries and DSL queries; and
b. training the neural network to learn a joint embedding space using the dataset, wherein a first pair of NL queries is similar in the joint embedding space and a second pair of NL queries is dissimilar in the joint embedding space, wherein the first pair of NL queries comprises lower sequence similarity than the second pair of NL queries, and wherein the first pair of NL queries comprises higher semantic similarity than the second pair of NL queries.

15. The method of claim 14, wherein the training comprises contrastive learning for learning the joint embedding space.

16. The method of claim 14, wherein the training comprises non-contrastive learning for learning the joint embedding space.

17. The method of claim 14, wherein the dataset comprises synthetic NL queries, synthetic DSL queries, or both.

18. The method of claim 17, wherein the synthetic NL queries, synthetic DSL queries, or both are generated to approximate or match user distribution of queries.

19. The method of claim 14, wherein the dataset comprises positive pairs and negative pairs of NL queries and DSL queries.

20. The method of claim 19, wherein the negative pairs comprise hard negatives sampled from user data.
